(19) United States
(12) Patent Application Publication
(10) Pub. No.: US 2013/0093153 A1
(43) Pub. Date: Apr. 18, 2013

(54) AUTOMOBILE STABILIZER BAR MANUFACTURING METHOD

(71) Applicants: Toru Ito, Nagoya-shi (JP); Yoshitaka Ukei, Nagoya-shi (JP)

(72) Inventors: Toru Ito, Nagoya-shi (JP); Yoshitaka Ukei, Nagoya-shi (JP)

(73) Assignee: CHUO HATSUJO KABUSHIKI KAISHA, Nagoya-shi (JP)

(21) Appl. No.: 13/634,608

(22) PCT Filed: Mar. 15, 2011
(86) PCT No.: PCT/JP2011/056050

§ 371 Date: Dec. 26, 2012

(30) Foreign Application Priority Data
Mar. 16, 2010 (JP) 2010-059611

(51) Int. Cl. B05D 3/14; B60G 21/055

(52) U.S. Cl. CPC B05D 3/14; B60G 21/055
USPC 280/124.107; 427/545

(57) ABSTRACT

A method of coating an automotive stabilizer bar having a curved portion and a straight portion includes electrically heating the stabilizer bar such that a surface temperature of the straight portion increases at a rate of 10-30° C./sec and then coating a surface of the electrically pre-heated stabilizer bar.

### TECHNICAL FIELD

The present application relates to a method that manufactures a stabilizer bar used in an automobile.

### DESCRIPTION OF RELATED ART

Methods for manufacturing a stabilizer bar used in a vehicle such as an automobile are disclosed in Laid-open Patent Publication No. 2006-206999 and Laid-open Patent Publication No. 2004-193033. In these manufacturing methods, steel (material) is subjected to bending and formed into a stabilizer-shape; the steel that has been formed into the stabilizer bar shape is heat treated. By performing the heat treatment on the steel that has been formed into the stabilizer bar, desired mechanical properties are imparted thereto. Moreover, in Laid-open Patent Publication No. 2006-206999, the use of electrical heating for quench-hardening of stabilizer bars is described. In addition, in Laid-open Patent Publication No. 2004-193033, performing quench-hardening and tempering on a stabilizer bar by electrical heating is described.

### SUMMARY OF THE INVENTION

### Problem to be Solved by the Invention

A surface of a stabilizer bar is coated in order to prevent life span reduction and property degradation due to corrosion. For the coating, a bakeable coating capable of forming a strong coating film is typically used. In previously-known coating methods, paint is sprayed onto the surface of a room-temperature stabilizer bar, then the stabilizer bar is heated in a heating furnace and the paint is baked onto the surface of the stabilizer bar.

With the previously-known coating method described above, in order to spray the paint onto the room-temperature stabilizer bar, there is the problem in that the period of time from spraying the paint until completion of the paint baking is prolonged. Therefore, a method of reducing the period of time between painting and completing of the paint baking by preheating the stabilizer bar using electrical heating capable of rapid heating and by painting the preheated stabilizer bar may be considered. In order to utilize such a method, variations in surface temperature(s) of the stabilizer bar must be kept within an allowable range and variations in the coating quality must also be kept within an allowable range. However, when a stabilizer bar having a curved portion is electrically heated, variations in surface temperatures at the curved portion become larger and variations of the coating quality cannot be kept within an allowable range. Therefore, so far, a method of preheating a stabilizer bar using electrical heating and coating the stabilizer bar has not been realized.

An object of the present application is to provide a technique that enables a stabilizer bar to be heated by electrical heating while controlling the rate of increase of the temperature(s) of the stabilizer bar to limit variations of the surface temperature(s) and, in turn, to enable a reduction in the period of time between paint-spraying and paint baking while maintaining the coating quality.

### Means for Solving the Problem

The present specification discloses a method that manufactures a stabilizer bar used in an automobile having a curved portion and a straight portion. This manufacturing method has an electrical heating step that electrically heats the stabilizer bar and a coating step that coats a surface of the electrically-heated stabilizer bar. Further, the heating step is performed such that the rate of increase of the surface temperature of the straight portion is 10-30° C./sec.

As a result of experiments carried out by the present inventors, it was found that variations of the surface temperatures of the stabilizer bar cannot be kept within an allowable range when, in the electrical heating step, the rate of increase of the temperature (hereinafter referred to as the base surface temperature) of the straight portion (in other words, a location other than the curved portion) of the stabilizer bar exceeds 30° C./sec. In addition, when the rate of increase of the base surface temperature of the stabilizer bar is less than 10° C./sec, preheating of the stabilizer bar takes a long period of time. With the manufacturing method described above, since the rate of increase of the base surface temperature of the stabilizer bar is set to the range of 10-30° C./sec, variations of the surface temperatures of the stabilizer bar in the coating step are kept within the allowable range, thereby enabling variations of the coating quality to be kept within an allowable range. In addition, since the stabilizer bar is preheated by electrical heating, the period of time between the paint-spraying and the conclusion of the paint baking can be reduced.

In the manufacturing method described above, the electrical heating step can have a first step in which the base surface temperature of the stabilizer bar is increased to a prescribed temperature (e.g., the baking coating temperature of the paint), and a second step that maintains the base surface temperature of the stabilizer bar at the prescribed temperature. In this case, it is preferred that the time period of the second step may be 10 seconds or less. According to this configuration, by providing the second step, homogenization of the surface temperature of the stabilizer bar can be achieved. Further, by setting the second step to 10 seconds or less, a prolongation of the electrical heating step is prevented.

The above-described manufacturing method is effective when it is used on a stabilizer bar having a hollow cross section. That is, a stabilizer bar having a hollow cross section may exhibit differences in thickness between an inner side and an outer side of the curved portion and may exhibit variations of surface temperatures between the inner side and the outer side of the curved portion. Thus, the above-described manufacturing method, which can limit variations of the surface temperatures of the stabilizer bar, is suitable as a manufacturing method of stabilizer bars having a hollow cross section. Here, the “inner side” of the curved portion refers to the side to which a compressive stress is applied in a bending step for forming the curved portion, and the “outer side” of the curved portion refers to the side to which a tensile stress is applied in the bending step for forming the curved portion.

Further, in the above-described method, it is preferable that the electrical heating step is performed while the inner side of the curved portion of the stabilizer bar is cooled. By cooling the inner side of the curved portion, variations of surface temperatures between the inner side and the outer side of the curved portion can be further limited.

### BRIEF DESCRIPTION OF DRAWINGS

FIG. 1 is a diagram illustrating a schematic configuration of a stabilizer bar according to an embodiment.

FIG. 2 is a flowchart illustrating a portion of a manufacturing process of a stabilizer bar.

FIG. 3 is a diagram illustrating an example of a temperature profile in an electrical heating step.

FIG. 4A is a diagram schematically illustrating the cross section of a straight portion (a location other than a curved portion).

FIG. 4B is a diagram schematically illustrating the cross section of a curved portion.

FIG. 5 is a first graph illustrating the relationship between rates of increase of temperature in the electrical heating step and the temperatures of a curved portion of the stabilizer bar.

FIG. 6 is a second graph illustrating the relationship between rates of increase of temperature in the electrical heating step and the temperature of a curved portion of the stabilizer bar.

### MODES FOR CARRYING OUT THE INVENTION

A manufacturing method of a stabilizer bar according to the present embodiment will be described. First, a stabilizer bar manufactured by the manufacturing method according to the present embodiment will be described. Because the stabilizer bar 10 will be mounted on an undercarriage of an automobile, it is formed from a rod-shaped steel material (e.g., SUP9 (Japanese Industrial Standards)). Steel materials having a solid cross section or steel materials having a hollow cross section (so-called pipe materials such as STKM13A and STKM15A (Japanese Industrial Standards)) can be used as the steel material for the stabilizer bar 10. Stabilizer bars 10 used in automobiles typically may be made with an outside diameter of φ20-30 mm. In addition, in case a pipe material is used as the stabilizer bar 10, its thickness may be set to 4-8 mm.

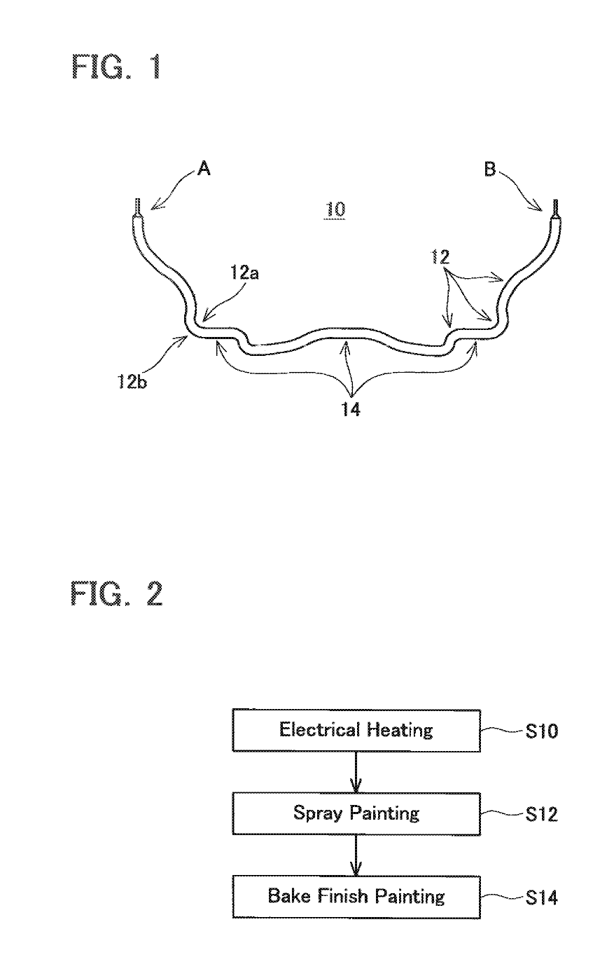

As illustrated in FIG. 1, the stabilizer bar 10 is formed with mounting parts A and B at its two ends; a plurality of curved portions 12 and a plurality of straight portions 14 are formed therebetween. The mounting parts A and B are processed into flat plate shapes and each has a bolt hole formed at their respective centers. The curved portion 12 is a portion in which its axis is bent. The straight portion 14 is a portion in which its axis is not bent. The curved portions 12 are appropriately provided for the purpose so that, e.g., the stabilizer bar 10 avoids interference with other parts of the automobile (a shaft, an engine, etc.). With the stabilizer bar 10 used in an automobile, the radius of curvature of the curved portion 12a is typically set to 30-80 mm.

The curved portions 12 are formed by cold bending or hot bending. Therefore, unlike locations other than the curved portions 12 (i.e., the straight portions 14), the cross-sectional shape of the curved portions 12 is deformed by bending. As a result, in an electrical heating step that will be described below, variations of surface temperatures are likely to occur between the inner side and the outer side of the curved portion 12. In particular, in case a pipe material is used as the stabilizer bar 10 (i.e. in case the stabilizer bar 10 has a hollow cross section), the thickness of the curved portion 12 differs between the inner side and the outer side. More specifically, during the bending for forming the curved portion(s) 12, compressive stress acts on the inner side 12a and tensile stress acts on the outer side 12b of the curved portion 12 (refer to FIG. 1). As a result, as illustrated in FIG. 4B, the inner side 12a of the curved portion 12 becomes thick-walled and the outer side 12b of the curved portion 12 becomes thin-walled. On the other hand, as illustrated in FIG. 4A, the thickness of the portions other than the curved portions 12 (the straight portions 14) is approximately constant around the entire circumference.

Moreover, as is apparent from FIGS. 1 and 4B, the inner side of the curved portion(s) 12 can otherwise be referred to as the side of the center of curvature of the curved portion, and the outer side of the curved portion 12 can otherwise be referred to as the side opposite to the center of curvature of the curved portion.

When mounting the stabilizer bar 10 described above onto an automobile, the mounting parts A and B at its two ends are affixed to the left and right wheels, and the center of the stabilizer bar 10 is affixed to a vehicle body. Due to the stabilizer bar 10 being installed on the automobile in this manner, rolling during turning of the automobile can be restrained and the driving stability of the automobile can be improved.

A manufacturing method of the stabilizer bar 10 will now be described. The manufacturing method of the stabilizer bar 10 has a first forming step in which mounting parts are formed by forge processing, etc., the two ends of a steel material; a second forming step in which the steel material is subjected to cold bending or hot bending to form the stabilizer bar shape; a heat treatment step in which the shaped stabilizer-shaped steel material is heat treated; and a bake coating step in which the heat-treated steel material is coated. Since the first and second forming steps and the heat treating step can be performed in the same manner as is conventional, a detailed description thereof will be omitted. Hereinafter, the bake coating step will be described in detail.

As illustrated in FIG. 2, in the bake coating step, the stabilizer bar 10 is first electrically heated (S10). In the electrical heating step of S10, the mounting part A on one end of the stabilizer bar 10 is clamped with an electrode, the mounting part B on the other end of the stabilizer bar 10 is clamped with another electrode, and a voltage is applied across the two electrodes. Accordingly, current flows from one end to the other end of the stabilizer bar 10 and the stabilizer bar 10 is heated by such Joule heating. The amount of heating of the stabilizer bar 10 can be controlled by the amount of current flowing through the stabilizer bar 10.

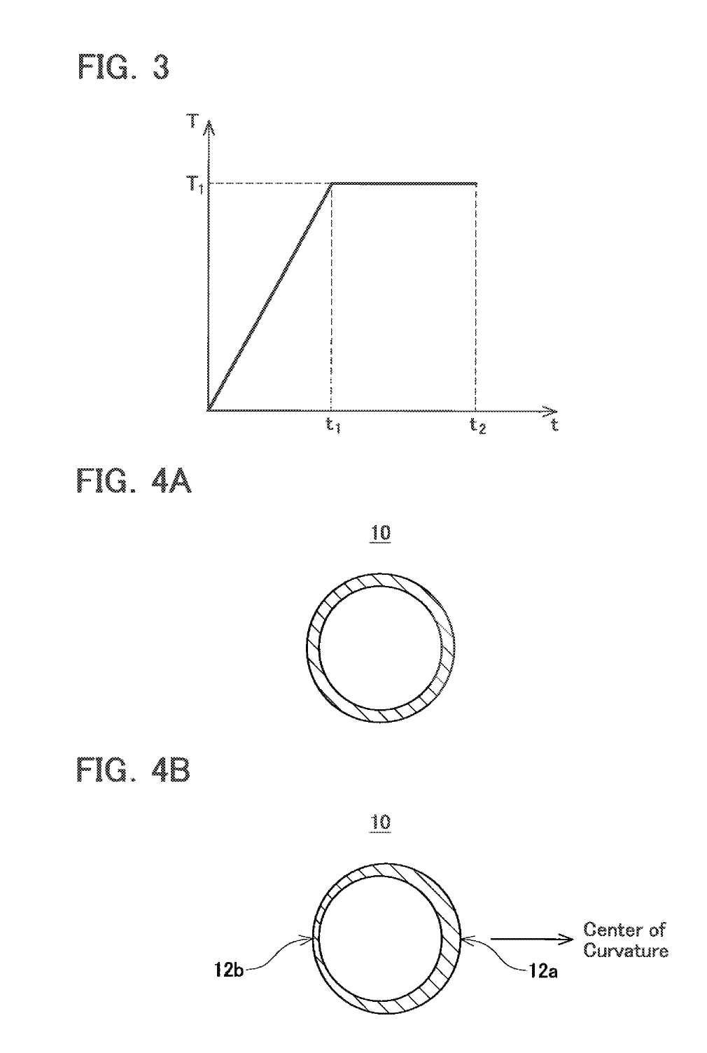

In the electrical heating step, as illustrated in FIG. 3, the first step (0 to t₁) in which the base surface temperature of the stabilizer bar 10 is heated to increase it up to a prescribed temperature T₁, and a second step (t₁ to t₂) in which the base surface temperature of the stabilizer bar 10 is maintained at the prescribed temperature T₁ may be performed. In this case, the “base surface temperature” of the stabilizer bar 10 refers to the surface temperature at a point appropriately set at a location other than the curved portion(s) 12 (i.e. a straight portion 14) of the stabilizer bar 10. In other words, the straight portion 14 is minimally influenced by the bending in the second forming step described above and, as illustrated in FIG. 4A, the thickness of its cross section is constant in the circumferential direction. Furthermore, in the electrical heating, the current flows in the axial direction of the stabilizer bar 10 and the amount of current or, in other words, the amount of heating does not vary in the axial direction. For this reason, the surface temperature of the straight portion(s) 14 remains approximately constant in the circumferential direction and in the axial direction. Therefore, in the present embodiment, the amount of electrical heating applied to the stabilizer bar 10 is controlled using the base surface temperature of the point set on the straight portion 14 of the stabilizer bar 10. As was described above, since the cross-sectional shape of the curved portion(s) 12 varies due to bending, variations of surface temperatures are likely to occur between the inner side and the outer side of the curved portion(s) 12 in the electrical heating step. In particular, in the example illustrated in FIG. 4B in which a pipe material is used as the stabilizer bar 10, the inner side of the curved portion 12 becomes thick-walled while the outer side of the curved portion 12 becomes thin-walled. Therefore, in the electrical heating step, the surface temperature of the inner side of the curved portion(s) 12 will become a higher temperature than the surface temperature of the outer side of the curved portion(s) 12.

In the next step (S14), the prescribed temperature T₁ described above can be set based on the baking coating temperature range of the sprayed-on paint. For example, in case the baking coating temperature range of the paint is 180-220° C., the prescribed temperature T₁ can be set at 200° C. In addition, the prescribed temperature T₁ can be decided with consideration of the transport time from the electrical heating equipment to the coating equipment. In other words, in case there is a long transport time from the electrical heating equipment to the coating equipment, the prescribed temperature T₁ may be set to a higher temperature than the upper limit of the baking coating temperature range.

Furthermore, in the first step described above, the rate of increase of the base surface temperature of the stabilizer bar 10 is controlled to be 10-30° C./sec. In case the rate of increase of the base surface temperature is less than 10° C./sec, a longer period of time is required for the surface temperature of the stabilizer bar 10 to reach the prescribed temperature T₁ (e.g., the baking coating temperature). In addition, the rate of increase of the base surface temperature of the stabilizer bar 10 is set to 30° C./sec or less, because a rate of increase exceeding 30° C./sec causes variations of the surface temperatures of the stabilizer bar 10 after the electrical heating to exceed an allowable range. Therefore, by heating in the range described above, the stabilizer bar 10 can be heated to the prescribed temperature T₁ while keeping variations of the surface temperatures of the stabilizer bar 10 within the allowable range.

Moreover, in the first step, the inner side(s) 12a of the curved portion(s) 12 may be cooled locally. Accordingly, even if the rate of increase of the base surface temperature of the stabilizer bar 10 is increased (e.g., to 20° C./sec or greater), differences between the surface temperature(s) of the inner side(s) 12a and the surface temperature(s) of the outer side(s) 12b of the curved portion(s) 12 can be kept within an allowable range. Moreover, methods that spray air or mist onto a site to be cooled or that use a cooling metal can be utilized as methods that locally cool the surface of the stabilizer bar 10.

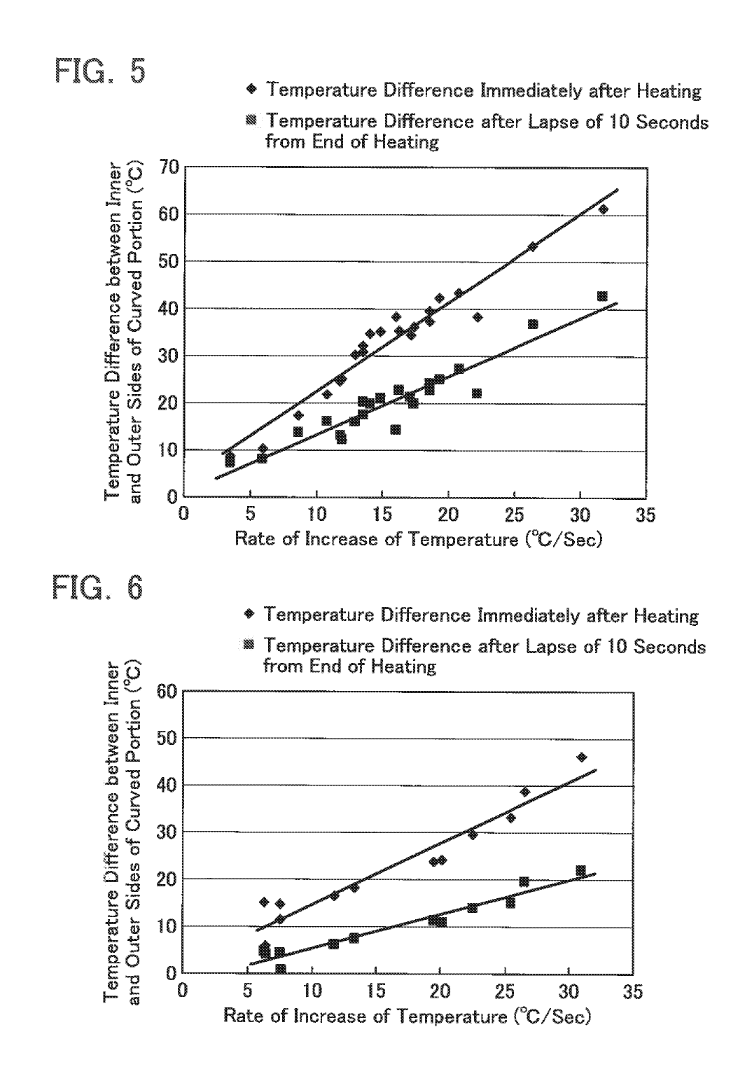

FIGS. 5 and 6 illustrate the results of measurements of the temperature differences between the inner side(s) and the outer side(s) of the curved portion(s) 12 while varying the rate of increase of the temperature (the rate of increase of the base surface temperature) of the stabilizer bar 10. The temperatures measurements were performed on a plurality of types of stabilizer bars formed from pipe materials having outer diameters of φ22-28 mm and thicknesses of 5.0-6.0 mm, and the radius of curvature of the curved portions where temperatures were measured was 30-80 mm. Furthermore, electrical heating was performed with the prescribed temperature T₁ set to 200° C. The temperature measurements were performed immediately after the end of heating and after a lapse of 10 seconds from the end of heating. The temperatures were measured after the lapse of 10 seconds because 10 seconds was considered to be the period of time required for transporting the stabilizer bar from an electrical heating device to a paint-spraying device. Therefore, if the surface temperature difference after the lapse of 10 seconds from the end of heating is within the allowable range, then the coating quality will be within the allowable range. Although the possible baking temperature range for paints is typically about 40° C., the temperature difference is preferably reduced to about 20° C. in consideration of coating qualities from an industrial perspective. Therefore, if the surface temperature difference after the lapse of 10 seconds from the end of heating is 20° C. or less, the coating quality will be considered to be within the allowable range. FIG. 5 is the results of measurements under the condition that the inner side of the curved portion was not cooled, and FIG. 6 is the results of measurements under the condition that the inner side of the curved portion was cooled by an air jet. As illustrated in FIG. 5, under the condition that the inner side of the curved portion was not cooled, the temperature difference between the inner side and the outer side of the curved portion could be limited to 20° C. or less by setting the rate of increase of the temperature to 15° C./sec or less. In addition, as illustrated in FIG. 6, under the condition that the inner side of the curved portion was cooled, the temperature difference between the inner side and the outer side of the curved portion could be limited to 20° C. or less by setting the rate of increase of the temperature to 30° C. or less. As is apparent from the results illustrated in FIGS. 5 and 6, it was confirmed that the temperature difference between the inner side and the outer side of the curved portion 12 cannot be kept within the allowable range if the rate of increase of the temperature exceeds 30° C./sec.

In the second step that is performed following the first step described above, the amount of current flowing through the stabilizer bar 10 is controlled so that the base surface temperature of the stabilizer bar 10 is maintained at the prescribed temperature T₁. For example, the surface temperature of the stabilizer bar 10 is measured by a thermocouple, thermography, etc. and the amount of current is controlled based on the measured surface temperature. Alternatively, the base surface temperature of the stabilizer bar 10 can be maintained at a constant temperature by switching a pre-set amount of current. By providing the second step, homogenization of the temperature of the entire stabilizer bar 10 can be achieved. Moreover, the period of time (t₁ to t₂) in which the second step is performed is preferably set to a range of 0-10 seconds. Specifically, in the first step, the prescribed temperature T₁ is set and, at the same time, the rate of increase of the temperature of the stabilizer bar 10 is limited to 10-30° C./sec. Therefore, the period of time in which the second step is performed may be appropriately decided depending on the period of time that has been allotted to the electrical heating step. For this reason, the second step may be performed for 0 seconds if only a short period of time has been allotted to the electrical heating step. In addition, by setting the second step to 10 seconds or less, a prolongation of the electrical heating step is prevented.

After the electrical heating step is concluded, the paint is sprayed onto the electrical-heated stabilizer bar 10 (S14) and then the paint sprayed onto the surface of the stabilizer bar 10 is baked (S16). The paint spraying step and the paint baking step can be performed in the same manner as is conventional. In the present embodiment, since the stabilizer bar 10 has been preheated in the electrical heating step, the paint sprayed onto the surface of the stabilizer bar 10 can be baked in a short period of time.

As was described in detail above, with the manufacturing method of the stabilizer bar 10 according to the present embodiment, temperature differences between the inner side and the outer side of the curved portion 12 can be kept within the allowable range by setting the rate of increase of the temperature of the stabilizer bar 10 in the electrical heating step to 30° C./sec or less. On the other hand, by setting the rate of increase of the temperature of the stabilizer bar 10 to 10° C./sec or more, a prolonged electrical heating step can be avoided. Therefore, the stabilizer bar 10 can be coated after heating by the electrical heating, and the period of time until conclusion of the paint baking can be reduced.

Moreover, in the embodiment described above, the two ends of the stabilizer bar 10 are clamped by electrodes and current is applied across the two ends of the stabilizer bar. However, the stabilizer bar may be divided in the axial direction and the amount of heat due to the currents flowing in the divided portions may be adjusted so that variations of surface temperatures do not occur.

While specific examples of the present invention have been described above in detail, these examples are merely illustrative and place no limitation on the scope of the patent claims. The technology described in the patent claims also encompasses various changes and modifications to the specific examples described above.

The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

1. A method of coating an automotive stabilizer bar, the method comprising:
applying an electric current across ends of the stabilizer bar such that at least one curved portion and at least one straight portion of the stabilizer bar are electrically pre-heated and such that a surface temperature of the at least one straight portion increases at a rate of 10-30° C./sec; and
coating a surface of the pre-heated stabilizer bar with paint.

2. The method as in claim 1, wherein the electrical heating step comprises:
first increasing the surface temperature of the straight portion of the stabilizer bar to a prescribed temperature, and
then maintaining the surface temperature of the straight portion at the prescribed temperature,
wherein the time period of the maintaining step is 10 seconds or less.

3. The method as in claim 2, wherein the stabilizer bar has a hollow cross section.

4. The method as in claim 3, further comprising:
cooling an inner surface of the at least one curved portion of the stabilizer bar during the electrical heating step.

5. The method as in claim 4, wherein the cooling step comprises:
spraying air or a mist onto the inner surface and/or
contacting the inner surface with a cooling metal.

6. The method as in claim 5, wherein the stabilizer bar has an outside diameter of φ20-30 mm.

7. The method as in claim 6, wherein the hollow stabilizer bar has a wall thickness of 4-8 mm.

8. The method as in claim 7, wherein the stabilizer bar comprises:
first and second mounting parts configured to be respectively affixed to left and right wheels of a vehicle and
a center portion configured to be affixed to a body of the vehicle.

9. The method as in claim 8, further comprising:
baking the coated stabilizer bar.

10. The method as in claim 9, wherein the prescribed temperature is 180-220° C.

11. The method as in claim 1, wherein the stabilizer bar has a hollow cross section.

12. The method as in claim 11, further comprising:
cooling an inner surface of the curved portion of the stabilizer bar during the electrical heating step.

13. The method as in claim 12, wherein the cooling step comprises:
spraying air or a mist onto the inner surface and/or
contacting the inner surface with a cooling metal.

14. The method as in claim 11, wherein the hollow stabilizer bar has a wall thickness of 4-8 mm.

15. The method as in claim 11, wherein the stabilizer bar has an outside diameter of φ20-30 mm.

16. The method as in claim 1, wherein the stabilizer bar comprises:
first and second mounting parts configured to be respectively affixed to left and right wheels of a vehicle and
a center portion configured to be affixed to a body of the vehicle.

17. The method as in claim 1, further comprising:
baking the coated stabilizer bar.

18. The method as in claim 2, wherein the prescribed temperature is 180-220° C.

19. A stabilizer bar for a vehicle produced according to the method of claim 10.

20. A stabilizer bar for a vehicle produced according to the method of claim 1.
